(19) United States
(12) Patent Application Publication
(10) Pub. No.: US 2002/0104731 A1
(43) Pub. Date: Aug. 8, 2002

(54) Pneumatic powered clutch linkage

(76) Inventors: Ernest L. Dockery, Garner, NC (US); Jerry L. Dockery, Raleigh, NC (US)

Correspondence Address: COATS & BENNETT, PLLC, P O BOX 5, RALEIGH, NC, 27602, US

(21) Appl. No.: 09/778,493

(22) Filed: Feb. 7, 2001

(51) Int. Cl. F16D 21/00; B60K 41/22

(52) U.S. Cl. 192/83; 192/3.62; 192/99 S; 192/85 C

(57) ABSTRACT

A pneumatic powered clutch linkage is provided. Forming a part of the pneumatic powered clutch linkage is a manual clutch linkage that includes a foot-operated clutch pedal that is operatively connected to a clutch rod or clutch actuating linkage through an interconnecting linkage. In conventional fashion, the clutch rod or clutch actuating linkage is connected to a clutch. In a manual mode of operation, the foot-operated clutch pedal can be depressed and in the course of depressing the clutch pedal the clutch rod or clutch actuating linkage is operative to disengage the clutch. In order to automatically actuate the clutch linkage, a pneumatic cylinder is operatively connected to the interconnecting linkage. A control valve that is adapted to be connected to a source of compressed air is connected to the pneumatic cylinder. By selectively actuating the control valve, compressed air can be directed to the pneumatic cylinder for actuating the same. In this automatic mode, the actuation of the pneumatic cylinder results in the manual clutch linkage being actuated which results in the clutch connected to the linkage being disengaged.

### FIELD OF THE INVENTION

The present invention relates to clutches and clutch assemblies and more particularly to a mechanical clutch linkage that includes a powered fluid cylinder for actuating a clutch.

### BACKGROUND OF THE INVENTION

It is appreciated that trucks of the tractor-trailer type generally employ a clutch assembly between a transmission and the fly-wheel of the truck. The clutch is generally actuated by a mechanical linkage that includes a foot-operated clutch pedal. As the truck moves from a standing start to a cruising speed, the transmission will typically be shifted through numerous gears. In this process, the driver of the vehicle will typically be required to repeatedly actuate the clutch and this is typically accomplished through a foot-operated clutch pedal. Because of the size of the typical clutch found in such trucks, it takes substantial strength to operate the clutch pedal and over a period of time this can require a substantial effort by the truck driver. This is especially hard on the truck driver as the truck moves through towns and cities where there is a significant amount of stop and go driving.

Therefore, there has been and continues to be a need for a powered clutch linkage that will enable the truck driver to automatically disengage the clutch without requiring the mechanical clutch pedal to be depressed.

### SUMMARY OF THE INVENTION

The present invention entails a pneumatic or fluid powered clutch assembly. The pneumatic powered clutch assembly includes a manual clutch linkage including a foot-operated clutch pedal that is operatively connected to a clutch rod or clutch actuating linkage through an interconnecting linkage such that the clutch rod or clutch actuating linkage can be actuated by depressing the clutch pedal. Operatively associated with the manual clutch linkage is a fluid or pneumatic cylinder that can be selectively actuated to cause the clutch rod or clutch actuating linkage to be moved. This, of course, is effective to disengage an associated clutch.

In one particular embodiment of the present invention, the fluid or pneumatic cylinder is actuated by a control valve that is disposed adjacent the transmission gear lever or on the transmission gear lever. The control valve is operative to connect to a supply line that is in turn connected to a source of compressed air. Extending between the control valve and the cylinder is a connecting line for delivering fluid or compressed air to the cylinder. Thus, it is appreciated that the control valve is in a very convenient location as the control valve can be actuated by the driver's hand as he or she is shifting the transmission gear lever.

Another aspect of the present invention entails a feature that permits the clutch to be disengaged either manually or through the fluid or pneumatic powered cylinder. This is accomplished by a design that incorporates the powered cylinder into the manual clutch linkage in such a way that the manual clutch linkage can be actuated manually even while the cylinder is connected to the manual clutch linkage. By the same token, when the powered cylinder is selectively actuated to disengage an associated clutch, the components that make up the manual clutch linkage are also moved back and forth. Thus, the total control linkage arrangement provides for either automatic or manual operation.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration depicting the pneumatic powered clutch assembly of the present invention.

FIG. 2 is a diagramatic perspective view illustrating the pneumatic powered clutch assembly of the present invention.

### DETAILED DESCRIPTION OF THE INVENTION

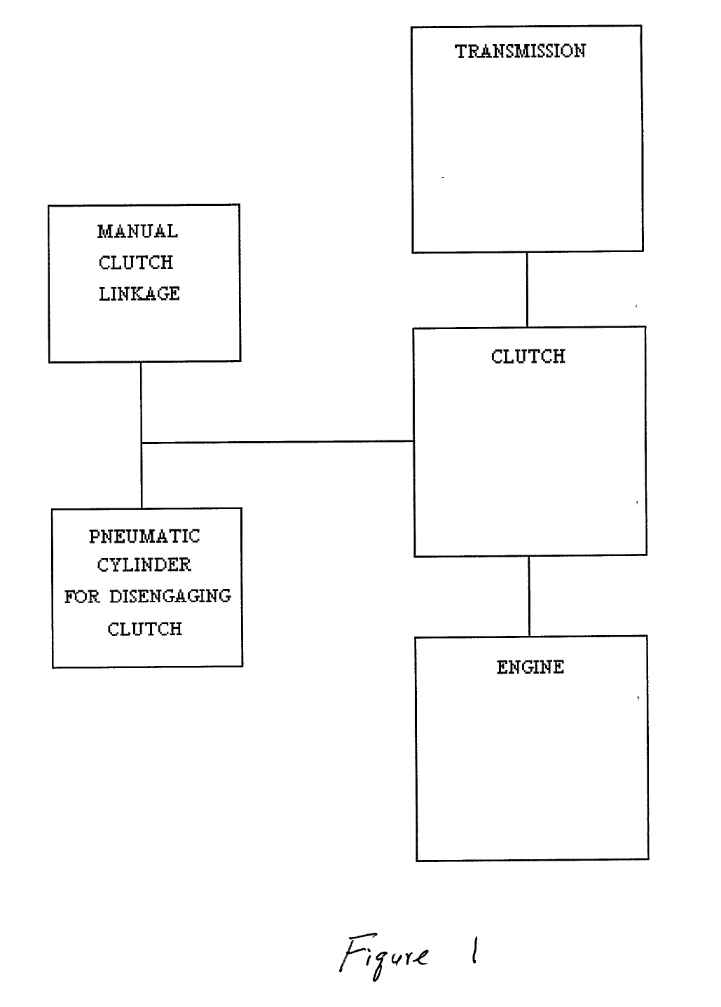

With further reference to the drawings, particularly FIG. 1, there is shown therein a schematic illustration that depicts how the pneumatic powered clutch assembly, indicated generally by the numeral 10, of the present invention works in conjunction with a mechanical clutch. In particular, as suggested by FIG. 1, there is provided a manual clutch linkage that is coupled directly to a clutch. In addition, there is provided a pneumatic cylinder that is operatively connected to the manual clutch linkage but is also operatively connected to the clutch for directly actuating the same. In conventional fashion, the clutch is interconnected between a transmission and an engine.

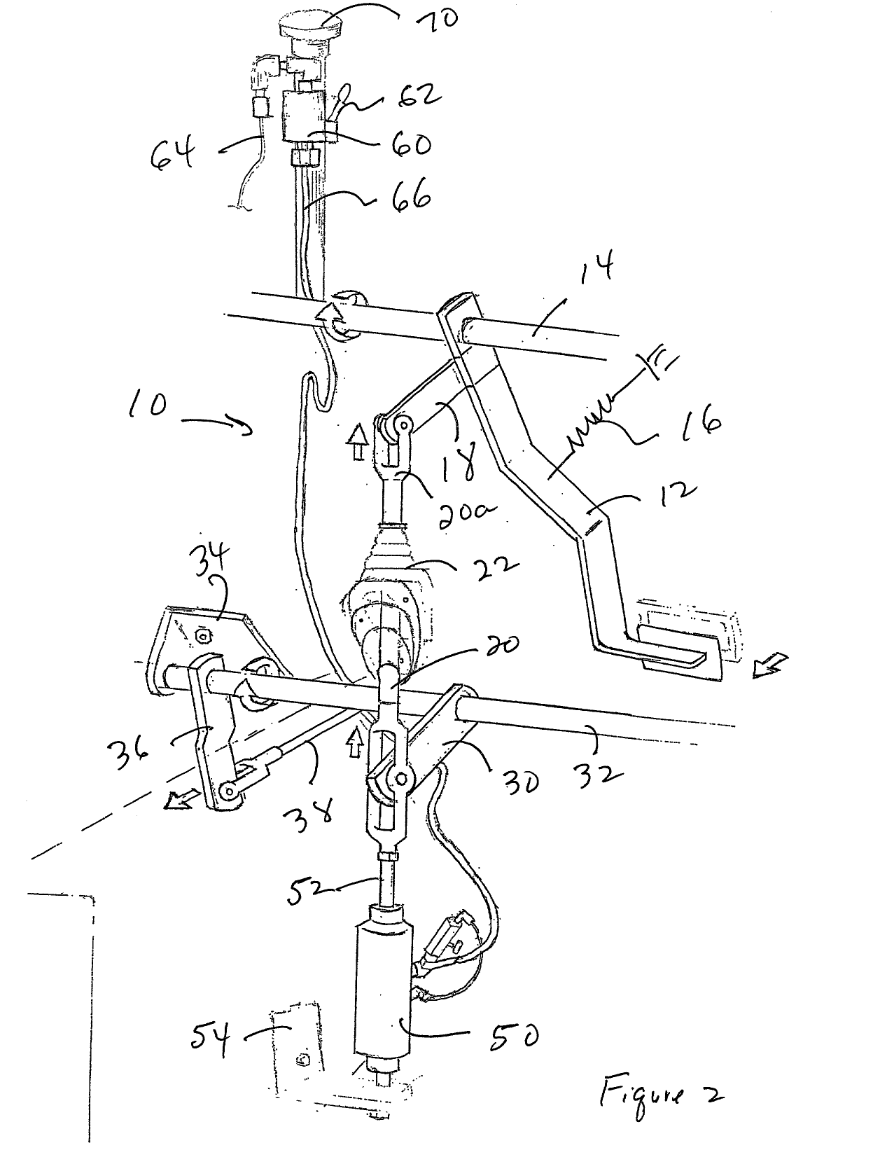

Turning to FIG. 2, there is shown therein a manual clutch linkage for actuating the clutch. Viewing the clutch linkage in detail, it is seen that is includes a clutch pedal 12 that is fixed to a rock shaft 14. Clutch pedal 12 is of the type normally disposed about the foot area of the driver's station and is adapted to be actuated by the foot of the driver. As seen in FIG. 1, as the operator depresses the clutch pedal 12, the rock shaft 14 is caused to rotate. The spring forces associated with the clutch tend to act through the clutch linkage to bias the clutch pedal 12 to the extended (nondepressed) position. That is the position where the clutch is engaged and is effective to cause driving torque to be transferred from the driveshaft of the engine to the transmission. To assure that the clutch pedal 12 normally assumes that extended position, a spring 16 can be secured directly or indirectly to the clutch pedal 12 to cause the clutch pedal to be biased towards the extended or non-depressed position.

Continuing to refer to the clutch linkage of FIG. 2, an arm link 18 is fixed to the clutch pedal 12 and extends therefrom. A connecting link 20 is pivotally connected to the arm link 18. Connecting link 20 extends through a rubber boot 22 and through the firewall (not shown) of the particular vehicle having the pneumatic power clutch linkage 10 of the present invention incorporated therein. Essentially, the connecting link 20 would extend through the firewall and the rubber boot 22 which tends to seal the opening through which the connecting link 22 extends.

Formed upon opposite ends of the connecting link 20 is a pair of yokes 20a and 20b. Note in FIG. 2 where yoke 20a pivotally connects to the arm link 18 extending from the clutch pedal 12. About the opposite end of the connecting link 20, the other yoke 20b pivotally connects to a link 30 that is in turn fixed to a second rock shaft 32. The second rock shaft 32 extends transversely and is secured in part at least within a bracket 34. That is, the rock shaft 32 can rotate back and forth with respect to the bracket 34 while being supported about one end by the same bracket.

Fixed to the rock shaft 32 adjacent the bracket 34 is a lever arm 36. The lever arm 36 is in turn secured to an elongated clutch rod or clutch actuating linkage 38. Thus, the rotation of the rock shaft 32 results in the lever arm 36 being moved back and forth which in turn causes the clutch rod 38 to be actuated. As will be appreciated, the movement of the clutch rod is operative to actuate the clutch which effectively causes the clutch to be disengaged in response to the clutch pedal being depressed.

Incorporated into the manual linkage just described, is a pneumatic cylinder 50 which is operative to automatically power the linkage and consequently actuate the clutch. As seen in FIG. 2, the pneumatic cylinder 50 is supported on a bracket 54 that is in turn fixed to the vehicle or truck having the system of the present invention incorporated therein. Extending from the pneumatic cylinder 50 is a rod 52 that includes a yoke secured on the terminal end thereof and the yoke is in turn pivotally connected to the link 30. Thus, as viewed in FIG. 2, it is seen that by extending the rod 52 from the pneumatic cylinder 50, that the clutch can be disengaged in the same manner as if the clutch pedal 12 were manually depressed.

To control the pneumatic cylinder 50, there is provided a control valve 60. While the control 60 can be secured in numerous locations in convenient reach of the driver of the vehicle, it is contemplated that the valve 60 of the present invention will be mounted adjacent the transmission gear shift lever 70 or mounted directly on the gear shift lever 70 as suggested in FIG. 2. The control valve 60 includes a finger or thumb actuator 62. The valve 60 is ported to connect to a pressure supply line 64. The pressure supply line would connect to a source of compressed air such as a compressed air tank that is typically carried on a large truck of the tractor-trailer type. Between the valve 60 and the pneumatic cylinder 50 is a connecting line 66. The connecting line 66 serves to direct compressed air from the control valve 60 to the pneumatic cylinder 50 or as a vent which vents air from the cylinder 50 back through the connecting lines 66 and out the valve 60.

The pneumatic cylinder 50, in this present design, is typically a single acting pneumatic cylinder. To actuate the pneumatic cylinder 50, compressed air is directed through the valve 60 into the connecting line 66. From the connecting line 66 air is directed into a lower or base portion of the pneumatic cylinder 50. A piston is contained within the pneumatic cylinder 50 and the compressed air engages the underside of the piston and moves the piston up, as viewed in FIG. 2. The upward movement of the piston, of course, results in the rod 52 of the pneumatic cylinder 50 being extended. This extension causes the link 30 to rotate which in turn drives the rock shaft 32. The rotation of the rock shaft 32 results in the clutch rod 38 being actuated. The actuation of the clutch rod 38 results in the clutch being disengaged.

Details of the clutch have not been dealt with herein because such is not per se material to the present invention and further conventional clutch designs are well known and appreciated by those skilled in the art. However, in the way of a brief description, a conventional clutch is disengaged when the clutch pedal is pressed down as this action causes a thrust pad to press on levers at the center of a rotating clutch cover. This effectively pulls the pressure plate away from the clutch plate and disconnects the flywheel which is, of course, turned by the crank shaft of the vehicle engine. Conversely, when the clutch pedal is allowed to be extended (that is not depressed) the springs force the pressure plate and the clutch plate against the flywheel and consequently results in driving torque from the engine being transferred through the clutch to the transmission.

From the forgoing discussion, it is appreciated that the present invention entails a conventional mechanical clutch to be powered or actuated through a powered fluid or pneumatic cylinder and thereby relieves the operator of the requirement of continuously and repeatedly actuating the clutch through a foot operated clutch pedal.

1. A pneumatic powered clutch linkage, comprising: a manual clutch linkage including a foot actuated clutch pedal operatively connected to a clutch actuating linkage through an interconnecting linkage such that the clutch actuating linkage can be actuated by depressing the clutch pedal; and a pneumatic cylinder operatively connected to the manual clutch linkage for selectively actuating said clutch actuating linkage.

2. The pneumatic powered clutch linkage of claim 1 further including a control valve operatively connected to the pneumatic cylinder for selectively directing compressed air to the pneumatic cylinder.

3. The pneumatic powered clutch linkage of claim 2 wherein the control valve is adapted to be mounted on a gear lever such that the valve can be conveniently actuated.

4. The pneumatic powered clutch linkage of claim 2 wherein said control valve is adapted to be connected to a supply line wherein the supply line furnishes compressed air to the control valve, and wherein there is provided a connecting line between the control valve and the pneumatic cylinder for directing supplied compressed air from the control valve to the pneumatic cylinder which results in the manual clutch linkage being actuated by the pneumatic cylinder.

5. The pneumatic powered clutch linkage of claim 4 wherein the control valve includes a finger actuator and wherein the selective actuation of the control valve by the finger actuator results in compressed air being directed from the supply line into the control valve and into the connecting line and onto the pneumatic cylinder.

6. The pneumatic powered clutch linkage of claim 1 wherein the interconnecting linkage includes a first link connected to the clutch pedal and extending therefrom; a connecting linkage connected to the first link and extending therefrom to where the connecting linkage connects to a second link that is in turn secured to a rock shaft that includes a lever arm secured thereto and which is connected to the clutch actuating linkage whereby the depression of the clutch pedal results in the rock shaft being rotated and the lever arm moved back and forth which results in the clutch actuating linkage being actuated.

7. The pneumatic powered clutch linkage of claim 6 wherein the pneumatic cylinder includes a rod that is operative to actuated the rock shaft.

8. The pneumatic cylinder of claim 7 wherein the rod of the pneumatic cylinder is connected to the second link and wherein the actuation of the pneumatic cylinder causes the second link to be moved which results in the rock shaft being rotated.

9. The pneumatic powered clutch linkage of claim 1 wherein the pneumatic cylinder includes a rod that extends therefrom and is connected to the interconnecting linkage, and wherein the pneumatic cylinder is adapted to permit the rod to move back and forth in response to the clutch pedal being manually actuated.

10. The pneumatic powered clutch linkage of claim 9 including a control valve operatively connected to the pneumatic cylinder through a connecting line and wherein the control valve includes an actuator and is adapted to be connected to a supply line that functions to deliver compressed air to the control valve, and wherein by actuating the actuator, compressed area directed into and through the valve and through the connecting line into the pneumatic cylinder results in the rod being extended from the pneumatic cylinder which results in the pneumatic cylinder actuating the clutch linkage.

11. A pneumatic powered clutch linkage, comprising:
a. a manual clutch linkage including a foot-operated clutch pedal;
b. a clutch;
c. a clutch actuating linkage operatively interconnected between the manual clutch linkage and the clutch for disengaging the clutch in response to the clutch pedal being depressed;
d. a fluid cylinder operative to actuate said clutch actuating linkage independently of the manual clutch linkage; and
e. a control valve operatively connected to the fluid cylinder for selectively actuating the fluid cylinder whereby the selective actuation of the fluid cylinder results in the clutch actuating linkage being actuated.

12. The pneumatic powered clutch linkage of claim 11 wherein the fluid cylinder is a pneumatic cylinder.

13. The pneumatic powered clutch linkage of claim 12 wherein the control valve is adapted to be mounted adjacent a gear lever.

14. The pneumatic powered clutch linkage of claim 13 wherein there is provided a connecting line between the control valve and the fluid cylinder and further the control valve is adapted to be connected to a supply line that furnishes compressed air to the control valve, and wherein the control valve includes an actuator that enables the control valve to be selectively actuated to cause compressed air to be directed from the supply line into the control valve and through the connecting line into the fluid cylinder.

15. A method for automatically disengaging a clutch that is connected to a manual clutch linkage that includes a foot-operated clutch pedal, comprising: connecting a pneumatic cylinder to the manual clutch linkage; connecting the pneumatic cylinder to a control valve that is operative to control the pneumatic cylinder; and selectively disengaging the clutch by actuating the pneumatic cylinder, whereby the clutch may be disengaged by either manually actuating the foot-operated clutch pedal or by actuating the pneumatic cylinder connected to the manual clutch linkage.

16. The method of claim 15 including the step of mounting the control valve on a gear lever such that the control valve can be actuated by the hand of an operator while the hand of the operator is engaged with the gear lever.
